(19) United States
(12) Patent Application Publication
(10) Pub. No.: US 2024/0151500 A1
(43) Pub. Date: May 9, 2024

(54) BALLISTIC GLASS AND METHODS OF FORMING SAME

(71) Applicant: Armitek LLC, Orem, UT (US)

(72) Inventors: Joshua Arthur Lyon, Springville, UT (US); James Eldon Lytle, Spanish Fork, UT (US)

(21) Appl. No.: 18/501,550

(22) Filed: Nov. 3, 2023

Related U.S. Application Data
(60) Provisional application No. 63/382,385, filed on Nov. 4, 2022.

(51) Int. Cl. F41H 5/04; B29C 45/00; B29C 45/14; B29C 51/00; B29C 51/12; B32B 17/10; B32B 27/36; B32B 27/40

(52) U.S. Cl. CPC F41H 5/0407; B29C 45/0001; B29C 45/14508; B29C 51/002; B29C 51/12; B32B 17/10018; B32B 17/10752; B32B 17/1077; B32B 27/365; B32B 27/40; B29L 2031/768

(57) ABSTRACT

A method of forming ballistic glass includes heat forming a polycarbonate panel while the polycarbonate panel is sandwiched between a non-planar glass panel and a mold panel such that the polycarbonate panel is formed to a geometry of the glass panel. The polycarbonate panel is positioned adjacent the glass panel such that a volume of space is defined therebetween, and the volume of space is filled with a flowable resin. The resin is cured to form an intermediate polymer layer between the polycarbonate panel and the glass panel. Ballistic glass may be formed using such methods. Vehicles may include such ballistic glass.

### CROSS-REFERENCE TO RELATED APPLICATION

This application claims the benefit under 35 U.S.C. § 119(e) of U.S. Provisional Patent Application Ser. No. 63/382,385, filed Nov. 4, 2022, the disclosure of which is hereby incorporated herein in its entirety by this reference.

### TECHNICAL FIELD

Embodiments of the present disclosure generally relate to ballistic glass, associated methods of forming ballistic glass, and to vehicles and structures including such ballistic glass.

### BACKGROUND

Ballistic glasses are used to protect people in vehicles, such as ground assault vehicles, personnel transportation, railcars, aircraft, among others, as well as buildings and other structures, such as houses, bunkers, and so forth, from ballistics and other threats. Ballistics may include, for example, projectiles such as bullets, shrapnel and/or waves generated by nearby explosions, among others.

Ballistic glasses commonly comprise a laminated structure of multiple materials, and typically include multiple layers or sheets of glass, plastic, resin, and/or other hard or resilient/elastic materials, which typically must remain transparent to visible light. When a ballistic projectile hits a ballistic glass, the plate (e.g., a glass sheet) of the ballistic glass exposed to the impact must withstand the perforation by the ballistic projectile, while the opposite side plate (e.g., a resilient layer such as a polymer layer) should stop fragments of the projectile and the exposed plate from penetrating completely through the ballistic glass. For example, most ballistic glass can be characterized as having an exterior side (e.g., strike side, the side of the ballistic glass that will be exposed to ballistic projectiles when used in, for example, armored vehicles), and an interior side (the side of the ballistic glass that will be facing, for example, a passenger cabin of a plane or ground vehicle).

### BRIEF SUMMARY

In some embodiments, the present disclosure includes a ballistic glass comprising a non-planar glass panel, a polycarbonate panel adhered to the non-planar glass panel and having a curved geometry at least substantially matching a curved geometry of the non-planar glass panel, and an intermediate layer of polymer material (such as polyurethane, for example) disposed between the glass panel and the polycarbonate panel.

In additional embodiments, the present disclosure includes a vehicle including a ballistic glass panel as described herein.

In yet further embodiments, the present disclosure comprises a method of fabricating ballistic glass. The method includes providing a non-planar glass panel, and providing a mold panel having a geometry at least substantially matching a geometry of the non-planar glass panel. A planar polycarbonate panel having a peripheral geometry corresponding to a peripheral geometry of the glass panel is also provided, and then formed to the geometry of the non-planar glass panel and the mold panel. As an example, the method may include sandwiching the polycarbonate panel between the non-planar glass panel and the mold panel for a period of time such that the polycarbonate panel is formed to the geometry of the non-planar glass panel and the mold panel. In some embodiments, heat may be applied to the polycarbonate panel for a period of time while it is sandwiched between the non-planar glass panel and the mold panel so as to heat form the polycarbonate panel to the geometry of the non-planar glass panel and the mold panel. Segmented spacer tape is applied to a side of the polycarbonate panel along and proximate a peripheral edge of the polycarbonate panel. In some embodiments, the segmented spacer tape may be separated from the peripheral edge of the polycarbonate panel by a relatively small distance. In other embodiments, the segmented spacer tape may be positioned directly along the peripheral edge of the polycarbonate panel. The segmented spacer tape comprises segments of tape having a predefined thickness and separated from one another by gaps. The polycarbonate panel is then assembled with the glass panel with the segmented spacer tape therebetween, and a bead of polymer material is applied along an interface between the polycarbonate panel and the glass panel adjacent the segmented spacer tape to form a seal between the polycarbonate panel and the glass panel around the periphery thereof except for at least a first gap and at least a second gap of the gaps separating the segments of spacer tape. A volume of space between the polycarbonate panel and the glass panel is then filled with a flowable resin comprising a polymer or a polymer precursor by flowing the resin into the volume of space through the at least a first gap while allowing gas to flow out from the volume of space through the at least a second gap. The resin is then cured to form an intermediate polymer layer between the polycarbonate panel and the glass panel.

### BRIEF DESCRIPTION OF THE DRAWINGS

For a detailed understanding of the present disclosure, reference should be made to the following detailed description, taken in conjunction with the accompanying drawings, in which like elements have generally been designated with like numerals, and wherein:

FIG. 1A is a plan view of an example embodiment of ballistic glass in accordance with the present disclosure;

FIG. 1B is a cross-sectional top view of the ballistic glass of FIG. 1A;

FIG. 1C is a cross-sectional side view of the ballistic glass of FIG. 1A;

FIG. 1D is an enlarged partial cross-sectional view like that of FIG. 1B of the ballistic glass of FIG. 1A;

FIGS. 2-9 are used to illustrate an example embodiment of a method of fabricating a ballistic glass like that of FIGS. 1A-1B in accordance with the present disclosure;

FIG. 2 is a plan view of an extruded planar polycarbonate sheet from which polycarbonate panels may be cut;

FIG. 3 is a cross-sectional side view illustrated a heat-forming process in which the planar polycarbonate sheet is sandwiched between a glass panel to which it will ultimately be assembled and a mold panel while heat is applied to the assembly;

FIG. 4 illustrates the heat-formed polycarbonate panel with segmented spacer tape applied to a side thereof along and proximate a peripheral edge of the panel;

FIG. 5 illustrates the polycarbonate panel assembled with a glass panel with segmented spacer tape therebetween, the segmented spacer tape applied to a side of the polycarbonate panel or the non-planar glass panel along and proximate a peripheral edge of the respective panel;

FIG. 6 illustrates spacers and tubes inserted into gaps between segments of the spacer tape between the polycarbonate panel and the glass panel;

FIG. 7A is a plan view illustrating a mold panel applied over the polycarbonate panel on a side thereof opposite the glass panel, the mold panel having a geometry at least substantially matching a geometry of the glass panel;

FIG. 7B is a cross-sectional view of the assembly of FIG. 7A illustrating the polycarbonate panel sandwiched between the glass panel and the mold panel;

FIG. 8 illustrates the assembly of FIG. 7B but further including a bead of polymer material applied along an interface between the polycarbonate and glass panels adjacent the segmented spacer tape to form a seal, as well as a polymer material filling a volume of space defined by the spacers and the segments of the spacer tape between the polycarbonate panel and the glass panel; and

FIG. 9 illustrates the assembly of FIG. 8 after removal of the mold panel and applying additional material to the interface between the polycarbonate and glass panels along the periphery thereof.

### DETAILED DESCRIPTION

The illustrations presented herein are not meant to be actual views of any particular ballistic glass assembly, associated tool, or components thereof, but are merely idealized representations employed to describe illustrative embodiments. The drawings are not necessarily to scale.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any ballistic glass when utilized in a conventional manner. Furthermore, these terms may refer to an orientation of elements of any ballistic glass or component thereof as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

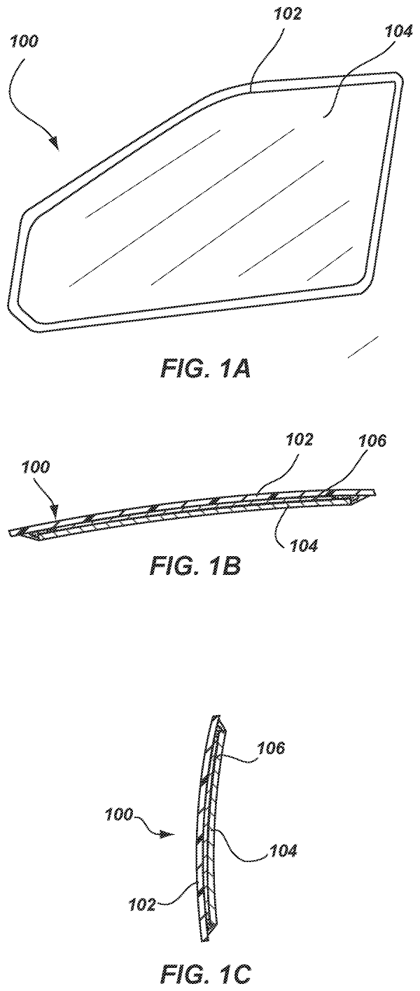

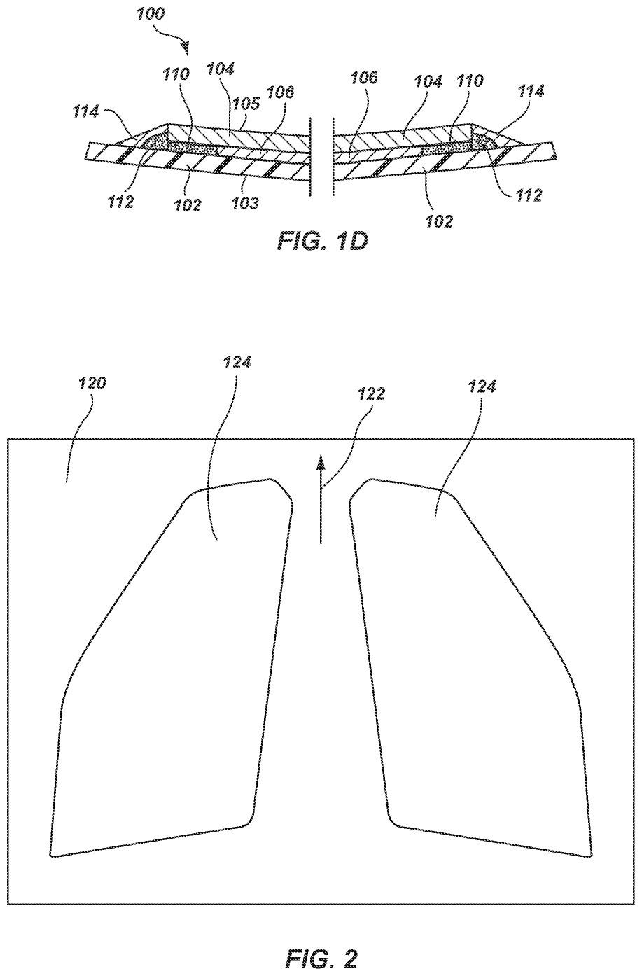

FIG. 1 is a plan view of an embodiment of a ballistic glass 100 according to the present disclosure. The ballistic glass 100 includes a glass panel 102, a polycarbonate panel 104, and an intermediate polymer layer 106 disposed between the glass panel 102 and the polycarbonate panel 104.

The glass panel 102 may be non-planar, although embodiments of the present disclosure also include flat, planar glass panels. The glass panel 102 may have any shape, such as rectangular, or polygonal. The glass panel 102 may have a thickness between 3 mm and 25 mm, or more particularly between about 3 mm and about 12 mm, such as 5.0 mm for example. In other embodiments, the glass panel 102 could be even thicker than 25 mm.

In some embodiments, the glass panel 102 may comprise a standard vehicle glass panel as manufactured by or for the manufacturer of any particular vehicle. The non-limiting example illustrated in FIGS. 1A-1D is a door window for a motor vehicle. In other embodiments, the glass panel 102 could be a front windshield of a ground, sea, or air vehicle, or any other window of a ground, sea, or air vehicle. Additional embodiments may include glass panels for buildings or other structures that may be occupied by humans and through which both visibility and protection from projectiles is desired. Yet further embodiments include ballistic shields, visors for helmets or goggles, and other smaller mobile devices.

The polycarbonate panel 104 is adhered to the non-planar glass panel 102 as discussed in further detail herein, and has a geometry at least substantially matching a geometry of the glass panel 102. For example, the glass panel 102 and the polycarbonate panel 104 may have at least substantially matching complementary non-planar curved geometries, as illustrated in FIGS. 1A-1D. In the illustrated embodiment, the periphery of the glass panel 102 extends outwardly slightly beyond the periphery of the polycarbonate panel 104 by a few millimeters. In other embodiments, however, the glass panel 102 and the polycarbonate panel 104 could have identical planar or non-planar geometries, or the glass panel 102 could be significantly larger or significantly smaller than the polycarbonate panel 104, depending upon the application and desired attributes of the ballistic glass 100.

The polycarbonate panel 104 may have a thickness between 3 mm and 10 mm, or more particularly between about 4 mm and about 8 mm, such as 6.4 mm for example.

As a non-limiting example, the polycarbonate panel 104 may comprise a transparent and abrasion-resistant polycarbonate material, such as that sold under the trade name TUFFAK© AR by Plaskolite of Columbus, Ohio.

As discussed in further detail herein below, in embodiments in which the polycarbonate panel 104 has a curved geometry and the polycarbonate panel 104 comprises an extruded thermoplastic material, the polycarbonate panel 104 may have a smallest radius of curvature extending along a first direction, and the polycarbonate panel 104 may have a direction of extrusion oriented at least substantially parallel to that first direction.

The intermediate polymer layer 106 comprises a polymer material capable of adhering the polycarbonate panel 104 to the glass panel 102. The polymer material may be transparent, and may have a coefficient of refraction similar to those of the glass panel 102 and the polycarbonate panel 104. The polymer material of the intermediate polymer layer 106 may also be significantly more ductile than the glass panel 102 and the polycarbonate panel 104. The polymer material may be a two-part polymer mixture in which two polymer precursor materials are mixed together in liquid form, but cure with time (and possibly application of heat or other energy) to form a ductile solid polymer material. As a non-limiting example, the intermediate polymer layer 106 may comprise a polyurethane material, such as that sold under the trade name POLYLAM by GlassLam of Pompano Beach, Florida.

The intermediate polymer layer 106 may have a thickness between 0.5 mm and 5 mm, or more particularly between about 1 mm and about 2 mm, such as 1.5 mm for example.

As shown in FIG. 1D, in some embodiments, a segmented spacer tape 110 may be disposed between the glass panel 102 and the polycarbonate panel 104 along the periphery of the interface therebetween. In some embodiments, the segmented spacer tape 110 may comprise a double-sided adhesive tape, for example. The segmented spacer tape 110 comprises segments of tape having a predefined thickness and separated from one another by gaps therebetween. As a non-limiting example, the segmented spacer tape 110 may comprise the tape sold under the trade name WORLDSPACER by GlassLam of Pompano Beach, Florida.

A bead of polymer material 112 may also be disposed along the periphery of the interface between the glass panel 102 and the polycarbonate panel 104 adjacent the segmented spacer tape 110 to form a seal between the glass panel 102 and the polycarbonate panel 104 around the periphery thereof except for adjacent two or more gaps separating adjacent segments of spacer tape 110. The bead of polymer material 112 may comprise, for example, a two part epoxy material, such as that sold by The Gorilla Glue Company of Cincinnati, Ohio. In other embodiments, the bead of polymer material 112 may comprise, for example, a hot-melt glue.

A chamfer material 114 may extend over the bead of polymer material 112 along the entire periphery of the interface between the glass panel 102 and the polycarbonate panel 104. The chamfer material 114 may comprise an elastomeric material provided a uniform and relatively smooth transition between the edge of the glass panel 102 and the edge of the polycarbonate panel 104. As a non-limiting example, the chamfer material 114 may comprise a polyurethane material, such as that sold under the trade name SIKAFLEX©-295 UV by the Sika Corporation of Lyndhurst, New Jersey.

An exposed surface 103 of the glass panel 102 defines an exterior surface of the ballistic glass 100, and an exposed surface 105 of the polycarbonate panel 104 defines an interior surface of the ballistic glass 100. In other words, the ballistic glass 104 is intended to protect a person on the interior side of the ballistic glass 100 adjacent the interior, exposed surface 105 of the polycarbonate panel 104 from projectiles that could impact the exterior, exposed surface 103 of the glass panel 102, while maintaining good visibility through the ballistic glass 100.

Additional embodiments of the present disclosure include vehicles, buildings, and mobile devices such as shields and visors comprising one or more panels of ballistic glass 100 as described herein.

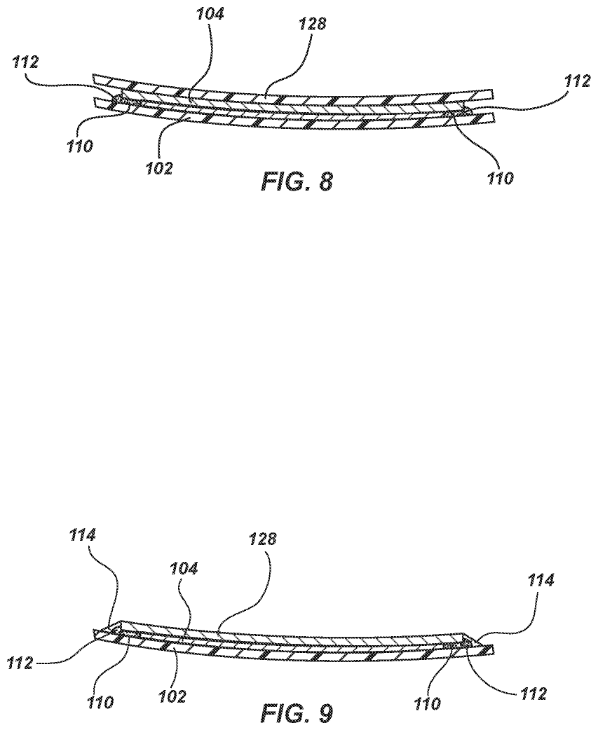

Yet further embodiments of the present disclosure include methods of manufacturing ballistic glass 100, as described herein below with reference to FIGS. 2-8.

In accordance with such methods, a glass panel 102 and a polycarbonate panel 104 are assembled together such that they are separated from one another by a predefined distance, a volume of space between the polycarbonate panel 104 and the glass panel 102 is filled with a flowable resin comprising a polymer or a polymer precursor by flowing the resin into the volume of space, and then curing the resin to form an intermediate polymer layer 106 between the polycarbonate panel 104 and the glass panel 102.

As previously discussed, in some embodiments, the glass panel 102 may be a non-planar glass panel 102, such as that illustrated in FIGS. 1A-1D. In such embodiments, a polycarbonate panel 104 having a geometry at least substantially matching the non-planar geometry of the glass panel 102 may be provided.

Polycarbonate panels, however, are typically formed by extrusion in planar panels. Thus, in accordance with some embodiments of the present disclosure, a forming process (such as a heat forming process or a sag forming process, for example) may be used to form a planar polycarbonate panel to have the geometry of a non-planar glass panel 102.

For example, as shown in FIG. 2, an extruded planar polycarbonate sheet 120 may be provided, which has a direction of extrusion as indicated by directional arrow 122 in FIG. 2. Manufacturers of such extruded planar polycarbonate sheets 120 typically mark the direction of extrusion on the panel itself, as the long chain polymer molecules of the material tend to be generally aligned in the direction of extrusion, which can result in some mechanical properties of the material being anisotropic relative to the direction of extrusion.

One or more planar polycarbonate panels 124 each having a peripheral geometry corresponding to the peripheral geometry of the glass panel 102 may be cut from the extruded planar polycarbonate sheet 120 using, for example, a water jet cutting process, a laser cutting process, or a mechanical machining process.

The polycarbonate panels 104 to be formed upon forming the planar polycarbonate panels 124 may have a non-planar curved geometry, and may be more or less curved in any particular direction extending across the polycarbonate panels 104. As is known per se, the degree of curvature of any particular surface can be defined by the radius of curvature, which is radius of a semi-circular arc coinciding with the surface. Thus, a highly curved surface will be defined by a shorter radius of curvature, and a slightly curved surface will be defined by a longer radius of curvature.

In accordance with embodiments of the present disclosure, the geometry of the polycarbonate panel 104 to be formed is a curved geometry having a smallest radius of curvature extending along a first direction, and the one or more planar polycarbonate panels 124 may be cut in an orientation relative to the extruded planar polycarbonate sheet 120 in which the first direction is oriented at least substantially parallel to the direction of extrusion 122 of the extruded planar polycarbonate sheet 120. This facilitates the subsequent forming process and may reduce the tendency of the polycarbonate panel 104 to “spring back” toward the planar geometry of the planar polycarbonate panel 124 after the forming process.

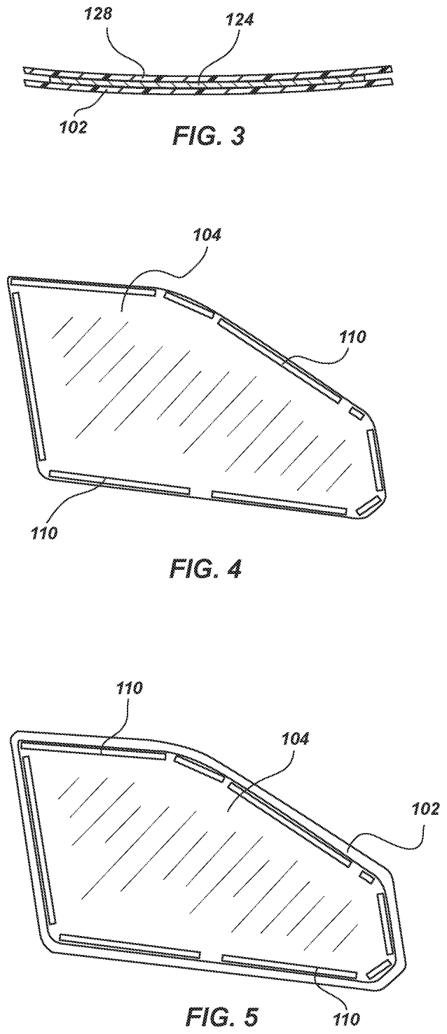

After cutting the planar polycarbonate panels 124 from the planar polycarbonate sheet 120, the planar polycarbonate panel 124 may be formed to form the polycarbonate panel 104. For example, a mold panel 128 having a geometry at least substantially matching a geometry of the non-planar glass panel 102 may be provided, and the polycarbonate panel 124 may be sandwiched and clamped between the glass panel 102 and the mold panel 128, as illustrated in FIG. 3, for a period of time. In some embodiments, the forming process may comprise a heat forming process in which heat is applied to the polycarbonate panel 124 for a period of time while the polycarbonate panel 124 is sandwiched and clamped between the glass panel 102 and the mold panel 128. As a non-limiting example, the polycarbonate panel 124 may be held between the glass panel 102 and the mold panel 128 at a temperature between about 100° C. and about 200° C. (e.g., about 150° C.) for a period of between 30 minutes and 6 hours (e.g., between 2 hours and 4 hours).

In some embodiments, the mold panel 128 may comprise a glass panel that is identical to the glass panel 102. In other words, in some embodiments, the polycarbonate panel 124 may be sandwiched and clamped between two identical glass panels 102, one of which will serve as a temporary mold panel 128 that does not become part of the ballistic glass 100 being formed.

Upon completion of the forming process, the polycarbonate panel 104 is obtained from the planar polycarbonate panel 124. The polycarbonate panel 104 then may be assembled with the glass panel 102 with the segmented spacer tape 110 (FIG. 1D) therebetween. For example, referring to FIG. 4, segmented spacer tape 110 may be applied to a side of the polycarbonate panel 104 or the non-planar glass panel 102 along and proximate a peripheral edge of the respective panel. FIG. 4 illustrates the segmented spacer tape 110 applied to the polycarbonate panel 104, but in additional embodiments, the segmented spacer tape 110 may first be applied to the glass panel 102. In some embodiments, the segmented spacer tape 110 may be separated from the peripheral edge of the respective panel (e.g., the polycarbonate panel 104 in the illustrated embodiment) by a distance of, for example, between 1 mm and 10 mm (e.g., about 6.5 mm). In other embodiments, an outer edge of the segmented spacer tape 110 may extend to and be aligned with the outer peripheral edge of the panel to which it is first applied.

As shown in FIG. 5, once the segmented spacer tape 110 is applied to a side of the polycarbonate panel 104 or the non-planar glass panel 102, the polycarbonate panel 104 and the glass panel 102 may be aligned with one another and assembled together with the segmented spacer tape 110 therebetween. A jig or template could be formed and used to facilitate the alignment of the polycarbonate panel 104 and the non-planar glass panel 102 while they are assembled together.

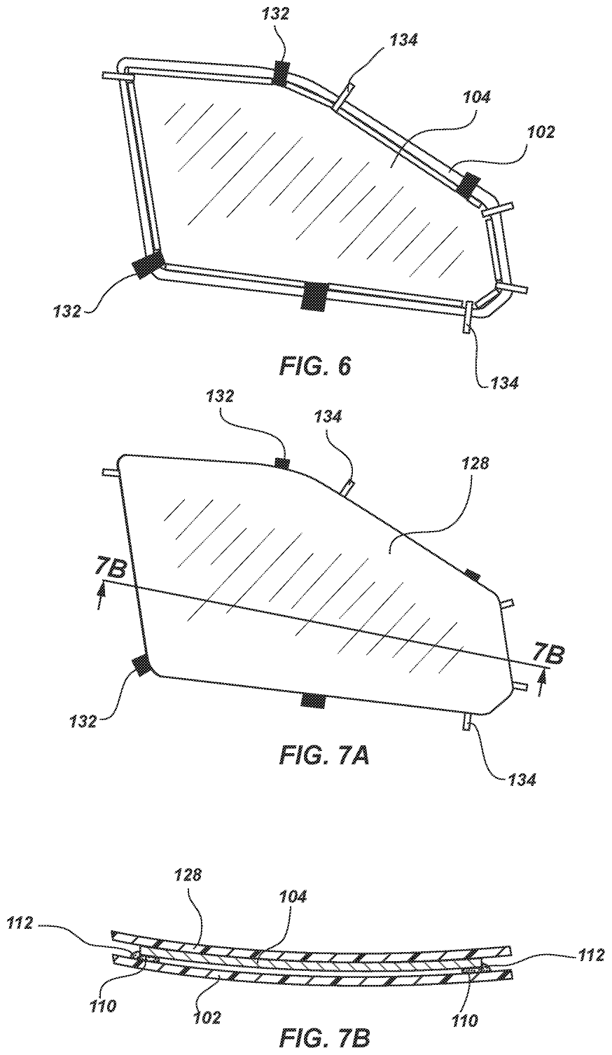

Referring to FIG. 6, at least one spacer 132 having a thickness at least substantially equal to a thickness of the segmented spacer tape 110 may be positioned in at least one of the gaps between the segments of tape 110. In the embodiment illustrated in FIG. 6, four spacers 132 are employed, but more or fewer spacers 132 may be employed in accordance with the present disclosure. The spacers 110 are more rigid than the segments of tape 110 and are used to maintain intended spacing between the polycarbonate panel 104 and the non-planar glass panel 102 during subsequent processing while the intermediate polymer layer 106 (FIGS. 1A-1D) is formed between the polycarbonate panel 104 and the glass panel 102. The spacers 132 may comprise a rigid plastic material, a metal material, or a ceramic material, for example.

As is also shown in FIG. 6, a tubular member 134 also may be positioned in at least one of the gaps between the segments of tape 110. The tubular member 134 may be used to facilitate the introduction of resin into the volume of space between the glass panel 102 and the polycarbonate panel 104, or the tubular member 134 may be used to facilitate the evacuation of gas out from the volume of space while it is being filled with the resin, as discussed below. In the embodiment illustrated in FIG. 6, five tubular members 134 are employed, but more or fewer tubular members 134 may be employed in accordance with the present disclosure.

After positioning the spacers 132 and tubular members 134 in the gaps between the segments of tape 110, the bead of polymer material 112 (FIGS. 1A-1D) may be applied along the interface between the polycarbonate panel 104 and the glass panel 102 adjacent the outer edge of the segmented spacer tape 110 to form a seal between the polycarbonate panel 104 and the glass panel 102 around the periphery thereof except at two or more gaps separating the segments of spacer tape 110. In particular, the bead of polymer material 112 is not applied at the locations of the spacers 132 and the tubular members 134. At least one gap must remain unsealed by the bead of polymer material 112 to allow for the introduction of resin, and at least one additional gap must remain unsealed by the bead of polymer material 112 to allow for the evacuation of gas as the resin is introduced into the space between the polycarbonate panel 104 and the glass panel 102.

Referring to FIGS. 7A-7B, the polycarbonate panel 104 optionally may be clamped between the glass panel 102 and a mold panel 128 (which may be similar or identical to the previously described mold panel 128) while the bead of polymer material 112 is applied to the assembly, and/or while resin is injected into the space between the polycarbonate panel 104 and the glass panel 102.

Referring to FIG. 9, the volume of space between the polycarbonate panel 104 and the glass panel 102 may then be filled with a flowable resin comprising a polymer or a polymer precursor by flowing the resin into the volume of space through at least one of the gaps in the segmented tape 110 while allowing gas to flow out from the volume of space through at least one of the gaps in the segmented tape 110. The liquid resin may be cured and solidified to form the intermediate polymer layer 106 between the polycarbonate panel 104 and the glass panel 106.

Optionally, a vacuum may be applied to the volume of space between the glass panel 102 and the polycarbonate panel 104 while the liquid resin is injected into the space to facilitate the flow of the resin and ensure that the space is fully filled with the liquid resin.

Once the liquid resin has fully cured and the intermediate polymer layer 106 has been formed between the polycarbonate panel 104 and the glass panel 106, the mold panel 128, the spacers 132, and the tubular members 134 may be removed. The chamfer material 114 then may be applied to the interface between the glass panel 102 and the polycarbonate panel 104 around the entire periphery of the assembly to provide a smooth and uniform transition between the edges of the glass panel 102 and the polycarbonate panel 104. Optionally, the bead of polymer material 112 may be removed prior to applying the chamfer material 114, such that the bead of polymer material 112 is not present in the final product.

Non-limiting example embodiments of the present disclosure may include:

Embodiment 1: A method of fabricating ballistic glass, comprising: providing a non-planar glass panel; providing a mold panel having a geometry at least substantially matching a geometry of the non-planar glass panel; providing a planar polycarbonate panel having a peripheral geometry corresponding to a peripheral geometry of the glass panel; heat forming the polycarbonate panel by applying heat to the polycarbonate panel for a period of time while sandwiching the polycarbonate panel between the non-planar glass panel and the mold panel such that the polycarbonate panel is formed to the geometry of the non-planar glass panel and the mold panel; applying segmented spacer tape to a side of the polycarbonate panel along and proximate a peripheral edge of the polycarbonate panel, but separated from the peripheral edge of the polycarbonate panel, the segmented spacer tape comprising segments of tape having a predefined thickness and separated from one another by gaps; assembling the polycarbonate panel with the glass panel with the segmented spacer tape therebetween; applying a bead of polymer material along an interface between the polycarbonate panel and the glass panel adjacent the segmented spacer tape to form a seal between the polycarbonate panel and the glass panel around the periphery thereof except for at least a first gap and at least a second gap of the gaps separating the segments of spacer tape; filling a volume of space between the polycarbonate panel and the glass panel with a flowable resin comprising a polymer or a polymer precursor by flowing the resin into the volume of space through the at least a first gap while allowing gas to flow out from the volume of space through the at least a second gap; and curing the resin to form an intermediate polymer layer between the polycarbonate panel and the glass panel.

Embodiment 2: The method of Embodiment 1, wherein the intermediate polymer layer comprises a polyurethane material.

Embodiment 3: The method of Embodiment 1 or Embodiment 2, wherein the intermediate polymer layer has a thickness between 0.5 mm and 5 mm.

Embodiment 4: The method of Embodiment 3, wherein the intermediate polymer layer has a thickness of about 1.5 mm.

Embodiment 5: The method of any one of Embodiments 1-4, wherein the polycarbonate panel has a thickness between 3 mm and 25 mm.

Embodiment 6: The method of Embodiment 5, wherein the polycarbonate panel has a thickness of about 6.4 mm.

Embodiment 7: The method of any one of Embodiments 1-6, wherein the glass panel has a thickness between 3 mm and 10 mm.

Embodiment 8: The method of Embodiment 7, wherein the glass panel has a thickness of about 5 mm.

Embodiment 9: The method of any one of Embodiments 1-8, wherein the geometry is a curved geometry having a smallest radius of curvature extending along a first direction, and wherein providing the planar polycarbonate panel comprises: providing an extruded planar polycarbonate sheet an having a direction of extrusion; and cutting the planar polycarbonate panel having the peripheral geometry corresponding to the peripheral geometry of the glass panel from the extruded planar polycarbonate sheet in an orientation relative to the extruded planar polycarbonate sheet in which the first direction is oriented at least substantially parallel to the direction of extrusion of the extruded planar polycarbonate sheet.

Embodiment 10: The method of any one of Embodiments 1-9, wherein the bead of polymer material comprises a bead of epoxy.

Embodiment 11: The method of any one of Embodiments 1-10, wherein filling the volume of space between the polycarbonate panel and the glass panel with the flowable resin comprising applying a vacuum to the volume of space while flowing the resin into the volume of space.

Embodiment 12: The method of any one of Embodiments 1-11, further comprising positioning at least one spacer having a thickness at least substantially equal to a thickness of the segmented spacer tape in at least one of the gaps between the segments of tape, the at least one spacer being more rigid than the segments of tape.

Embodiment 13: A ballistic glass, comprising: a non-planar glass panel; a polycarbonate panel adhered to the non-planar glass panel and having a curved geometry at least substantially matching a curved geometry of the non-planar glass panel; and an intermediate layer of polyurethane disposed between the glass panel and the polycarbonate panel.

Embodiment 14: The ballistic glass of Embodiment 13, wherein the intermediate layer of polyurethane has a thickness between 0.5 mm and 5 mm.

Embodiment 15: The ballistic glass of Embodiment 14, wherein the intermediate layer of polyurethane has a thickness of about 1.5 mm.

Embodiment 16: The ballistic glass of any one of Embodiments 13-15, wherein the polycarbonate panel has a thickness between 3 mm and 10 mm.

Embodiment 17: The ballistic glass of Embodiment 16, wherein the polycarbonate panel has a thickness of about 6.4 mm.

Embodiment 18: The ballistic glass of any one of Embodiments 13-17, wherein the glass panel has a thickness between 3 mm and 10 mm.

Embodiment 19: The ballistic glass of Embodiment 18, wherein the glass panel has a thickness of about 5 mm.

Embodiment 20: The ballistic glass of any one of Embodiments 13-19, wherein the curved geometry of the polycarbonate panel has a smallest radius of curvature extending along a first direction, and wherein the polycarbonate panel comprises an extruded material having a direction of extrusion oriented at least substantially parallel to the direction of extrusion of the extruded material.

Embodiment 21: A vehicle comprising at least one ballistic glass panel in accordance with any one of Embodiments 13-20.

Embodiment 22: A building comprising at least one ballistic glass panel in accordance with any one of Embodiments 13-20.

Embodiment 23: A shield comprising at least one ballistic glass panel in accordance with any one of Embodiments 13-20.

Embodiment 24: A visor comprising at least one ballistic glass panel in accordance with any one of Embodiments 13-20.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method of fabricating ballistic glass, comprising:
providing a non-planar glass panel;
providing a mold panel having a geometry at least substantially matching a geometry of the non-planar glass panel;
providing a planar polycarbonate panel having a peripheral geometry corresponding to a peripheral geometry of the glass panel;
heat forming the polycarbonate panel by applying heat to the polycarbonate panel for a period of time while sandwiching the polycarbonate panel between the non-planar glass panel and the mold panel such that the polycarbonate panel is formed to the geometry of the non-planar glass panel and the mold panel;
assembling the polycarbonate panel with the glass panel with segmented spacer tape therebetween, the segmented spacer tape applied to a side of the polycarbonate panel or the non-planar glass panel along and proximate a peripheral edge of the respective panel, but separated from the peripheral edge of the respective panel, the segmented spacer tape comprising segments of tape having a predefined thickness and separated from one another by gaps;
applying a bead of polymer material along an interface between the polycarbonate panel and the glass panel adjacent the segmented spacer tape to form a seal between the polycarbonate panel and the glass panel around the periphery thereof except for at least a first gap and at least a second gap of the gaps separating the segments of spacer tape;
filling a volume of space between the polycarbonate panel and the glass panel with a flowable resin comprising a polymer or a polymer precursor by flowing the resin into the volume of space through the at least a first gap while allowing gas to flow out from the volume of space through the at least a second gap; and
curing the resin to form an intermediate polymer layer between the polycarbonate panel and the glass panel.

2. The method of claim 1, wherein the intermediate polymer layer comprises a polyurethane material.

3. The method of claim 1, wherein the intermediate polymer layer has a thickness between 0.5 mm and 5 mm.

4. The method of claim 1, wherein the intermediate polymer layer has a thickness of about 1.5 mm.

5. The method of claim 1, wherein the polycarbonate panel has a thickness between 3 mm and 25 mm.

6. The method of claim 5, wherein the polycarbonate panel has a thickness of about 6.4 mm.

7. The method of claim 1, wherein the glass panel has a thickness between 3 mm and 10 mm.

8. The method of claim 1, wherein the glass panel has a thickness of about 5 mm.

9. The method of claim 1, wherein the geometry is a curved geometry having a smallest radius of curvature extending along a first direction, and wherein providing the planar polycarbonate panel comprises:
providing an extruded planar polycarbonate sheet and having a direction of extrusion; and
cutting the planar polycarbonate panel having the peripheral geometry corresponding to the peripheral geometry of the glass panel from the extruded planar polycarbonate sheet in an orientation relative to the extruded planar polycarbonate sheet in which the first direction is oriented at least substantially parallel to the direction of extrusion of the extruded planar polycarbonate sheet.

10. The method of claim 1, wherein the bead of polymer material comprises a bead of epoxy.

11. The method of claim 1, wherein filling the volume of space between the polycarbonate panel and the glass panel with the flowable resin comprising applying a vacuum to the volume of space while flowing the resin into the volume of space.

12. The method of claim 1, further comprising positioning at least one spacer having a thickness at least substantially equal to a thickness of the segmented spacer tape in at least one of the gaps between the segments of tape, the at least one spacer being more rigid than the segments of tape.

13. A ballistic glass, comprising:
a non-planar glass panel;
a polycarbonate panel adhered to the non-planar glass panel and having a curved geometry at least substantially matching a curved geometry of the non-planar glass panel; and
an intermediate layer of polyurethane disposed between the glass panel and the polycarbonate panel.

14. The ballistic glass of claim 13, wherein the intermediate layer of polyurethane has a thickness between 0.5 mm and 5 mm.

15. The ballistic glass of claim 13, wherein the intermediate layer of polyurethane has a thickness of about 1.5 mm.

16. The ballistic glass of claim 13, wherein the polycarbonate panel has a thickness between 3 mm and 10 mm.

17. The ballistic glass of claim 13, wherein the polycarbonate panel has a thickness of about 6.4 mm.

18. The ballistic glass of claim 13, wherein the glass panel has a thickness between 3 mm and 10 mm.

19. The ballistic glass of claim 13, wherein the glass panel has a thickness of about 5 mm.

20. The ballistic glass of claim 13, wherein the curved geometry of the polycarbonate panel has a smallest radius of curvature extending along a first direction, and wherein the polycarbonate panel comprises an extruded material having a direction of extrusion oriented at least substantially parallel to the first direction.
